(19) United States
(12) Patent Application Publication
(10) Pub. No.: US 2004/0184468 A1
(43) Pub. Date: Sep. 23, 2004

(54) Gateway device and cross-region transferring system

(76) Inventor: Yean Ching Miao, Banchiau City (TW)

Correspondence Address: BIRCH STEWART KOLASCH & BIRCH, PO BOX 747, FALLS CHURCH, VA, 22040-0747, US

(21) Appl. No.: 10/392,973

(22) Filed: Mar. 21, 2003

(51) Int. Cl. H04L 12/66

(52) U.S. Cl. 370/401

(57) ABSTRACT

A gateway device that cooperates with a regional network, a terminal device, and a cross-region transferring server. The gateway device includes a first I/O module, an inquiring signal-generating module, a second I/O module, and an analysis module. The first I/O module receives the destination of an output signal from the terminal device. The inquiring signal generating module generates a region distinguishing information-inquiring signal according to the destination of the output signal. The second I/O module outputs the region distinguishing information-inquiring signal to the destination of the output signal via the regional network, and then receives region distinguishing information from the destination of the output signal. The analysis module analyses the region distinguishing information to determine whether or not the destination of the output signal is located in the regional network. In this case, when the destination of the output signal isn't located in the regional network, the second I/O module outputs the output signal to the cross-region transferring server via the regional network, and then the cross-region transferring server transfers the output signal to the destination of the output signal. The invention also discloses a cross-region transferring system, which includes the gateway device, the regional network and a cross-region transferring device.

### BACKGROUND OF THE INVENTION

1. Field of Invention

The invention relates to a gateway device and, in particular, to a gateway device for transferring data between different regional networks.

2. Related Art

As the acceptance of the Internet has grown widespread, related industries have risen and flourished. In general, a user must register an IP address to an ISP (Internet Service Provider) in advance, and then configure a gateway or terminal device, such as a PC or a VoIP device, with a provided IP address. Having completed these requirements, a user can then utilize the terminal and gateway device to connect to a regional network provided by the ISP. A user can then browse the Internet via that regional network.

Many ISPs, however, do not own their network cables or any of the infrastructure required for constructing regional networks. It is common for many ISPs to lease one or more network cables from other providers, and some ISPs even share bandwidth with other ISPs. Additionally, the ISPs must cooperate with each other, to ensure that users are able to connect to a desired IP address located in another regional network provided by another ISP.

With reference to FIG. 1, there are four regional networks 11˜14 presented in Internet 10. A first terminal device 21 connects to the first regional network 11 through a gateway device 31. Similarly, second and third terminal devices 22, 23 respectively connect to the second and third regional network 12, 13 through gateway devices 32, 33. In this case, the first regional network 11 connects to the third and fourth regional networks 13, 14. The second regional network 12 connects to the third and fourth regional networks 13, 14. The third regional network 13 connects to the first, second and fourth regional networks 11, 12, 14. The fourth regional network 14 connects to the first, second and third regional networks 11, 12, 13. It should be noted that the data transmission speed between the regional networks is dependent upon the contract signed by the ISPs.

In practice, if the first terminal device 21 transfers data to the third terminal device 23, the data would then be output from the first terminal device 21 to the gateway device 31. The gateway device 31 would then output the packet formation data to the first regional network 11. Next, the packets are transferred from the first regional network 11 to the third regional network 13, and then are transferred from the third regional network 13 to the gateway device 33. Finally, the data can be successfully transferred from the gateway device 33 to the third terminal device 23. In this case, the data output from the first terminal device 21 is a voice analog signal or digital signal. If the data output from the first terminal device 21 is a voice analog signal, the gateway device 31 will translate the received voice analog signal into a digital signal and fragment the digital signal into several packets. The packets are then transferred to the gateway device 33, and the gateway device 33 can then reassemble and translate the packets into the original voice analog signal. After that, the voice analog signal is transferred to the third terminal device 23.

An alternative method does not require the packets to be transferred directly from the first regional network 11 to the third regional network 13. The packets could instead be transferred to the fourth regional network 14 first, and then be transferred from the fourth regional network 14 to the third regional network 13. Similarly, if the data is transferred from the first terminal device 21 to the second terminal device 22, the data will be fragmented into several packets, and be transferred via the gateway device 31, the first regional network 11, the fourth regional network 14, the second regional network 12, and the gateway device 32 in turn. The data may also be transferred via the gateway device 31, the first regional network 11, the third regional network 13, the second regional network 12, and gateway device 32 in turn.

Since data transmission capacity and speed may be limited by contracts between ISPs, the packets are not necessarily being transferred to the destination via the proper (fastest) path. For instance, it is assumed that the first regional network 11 and the fourth regional network 14 are in Taiwan, the third regional network 13 is in California, and the ISPs providing the first, third and fourth regional network 11, 13, 14 have contractual agreements with each other. Under these contracts, the data transmission speed is 100 MB/sec between the first and fourth regional networks, 2 MB/sec between the first and third regional networks, and 10 MB/sec between the third and fourth regional networks. If the packets are transferred via the gateway device 31, first regional network 11 and third regional network 13 in turn, the maximum data transmission speed of the packets degrades to 2 MB/sec. If the packets are transferred via the gateway device 31, first regional network 11, fourth regional network 14 and third regional network 13 in turn, the maximum potential data transmission speed of the packets is 10 MB/sec. Accordingly, when the packets further pass through the fourth regional network 14, the data transmission speed between gateway device 31 and gateway device 33 could increase. That is, the preferred transfer path from gateway device 31 to gateway device 33 is via the first regional network 11, fourth regional network 14 and third regional network 13 sequentially.

In reality, the market mechanism is fluid and changes rapidly. For example, the ISPs providing the first and third regional networks 11, 13 could re-sign the contract to increase the data transmission speed between the first and third regional networks 11, 13 up to 30 MB/sec. Thus, when the packets are transferred from the first regional network 11 to the third regional network 13 directly, the data transmission speed between gateway device 31 and gateway device 33 is enhanced.

As mentioned above, when packets are transferred over a conventional regular network, the transfer path is not necessarily the preferred path. For instance, after the ISPs providing the first and third regional networks 11, 13 have re-signed the contract to increase the data transmission speed, the packets might not be transferred via the desired, better path at present but via the path established by the previous contracts. Thus, the packets are still transferred via the first regional network 11, the fourth regional network 14 and third regional network 13 in turn.

As mentioned above, it is an important objective of the invention to provide a gateway device for transferring packets via assigned or desired data transmission paths.

### SUMMARY OF THE INVENTION

In view of the previously mentioned problems, an objective of the invention is to provide a gateway device for transferring packets via an assigned specific network.

To achieve the above-mentioned objective, the invention provides a gateway device including a first I/O module, an inquiring signal-generating module, a second I/O module, and an analysis module. In the invention, the IP address of the gateway device is located in a regional network, and the gateway device is signally connected with a terminal device and cooperates with a cross-region transferring server. The first I/O module receives the destination of an output signal from the terminal device. The inquiring signal generating module generates a region distinguishing information-inquiring signal according to the destination of the output signal. The second I/O module outputs the region distinguishing information-inquiring signal to the destination of the output signal via the regional network, and then receives region distinguishing information from the destination of the output signal. The analyzing module analyses the region distinguishing information to determine whether the destination of the output signal is located in the regional network or not. If not, the second I/O module outputs the output signal to the cross-region transferring server via the regional network, and then the cross-region transferring server transfers the output signal to the destination of the output signal.

As previously mentioned, the gateway device of the invention determines in advance whether the destination of the output signal is located in another regional network or not. If so, the output signal is transferred to the cross-region transferring server. The packets can then be transferred via an assigned specific network, which is part of the cross-region transferring server.

### BRIEF DESCRIPTION OF THE DRAWINGS

The invention will become more fully understood from the detailed description given hereinbelow illustration only, and thus are not limitative of the present invention, and wherein:

FIG. 1 is a schematic diagram showing the conventional Internet structure;

FIG. 2 is a schematic diagram showing a gateway device according to a preferred embodiment of the invention;

FIG. 3 is a schematic diagram showing the structure of several cross-region transferring systems according to a preferred embodiment of the invention;

FIG. 4 is a flow chart showing the application of the cross-region transferring systems according to a preferred embodiment of the invention;

FIG. 5A is a schematic diagram showing a packet transferred from the first gateway device to the first cross-region transferring device; and

FIG. 5B is a schematic diagram showing a packet transferred from the second cross-region transferring device to the second gateway device.

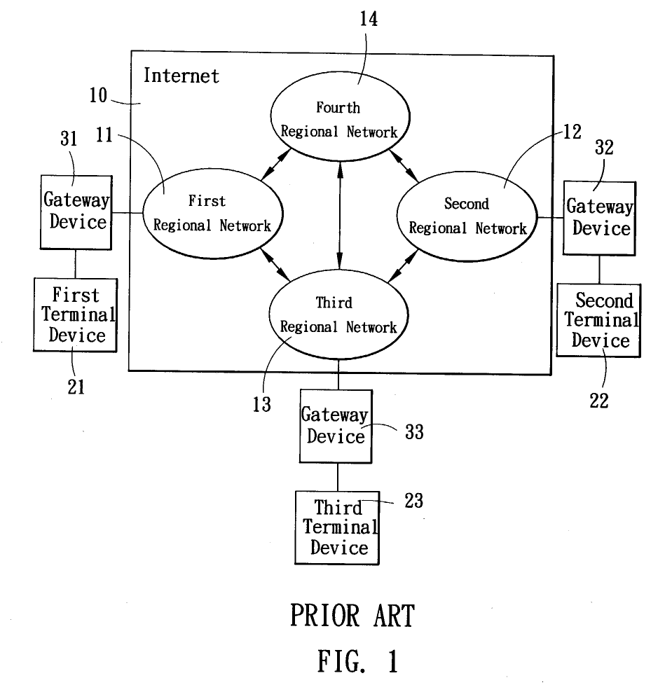

### DETAILED DESCRIPTION OF THE INVENTION

The gateway device according to the preferred embodiment of the invention will be described hereinbelow with reference to the accompany drawings, wherein the same reference numbers refer to the same elements.

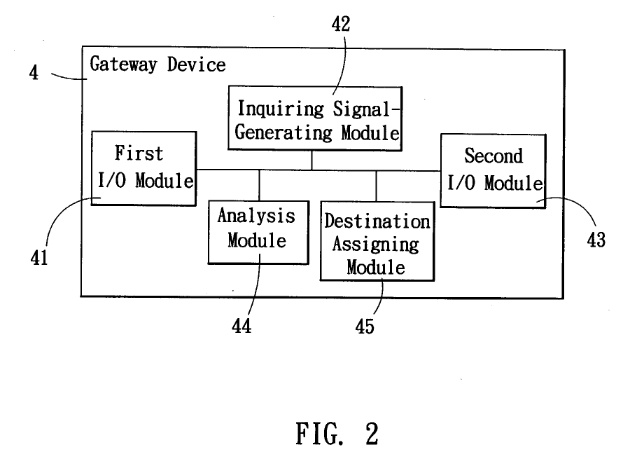

With reference to FIG. 2, a gateway device 4 according to a preferred embodiment of the invention includes a first I/O module 41, an inquiring signal-generating module 42, a second I/O module 43, an analysis module 44, and a destination assigning module 45.

In the invention, the first I/O module 41 receives the destination of an output signal, which could be a digital signal, an analog signal or a voice signal. The inquiring signal-generating module 42 generates a region distinguishing information-inquiring signal based on the destination of the output signal. The second I/O module 43 outputs the region distinguishing information-inquiring signal of packet formation to the destination of the output signal. Then, the second I/O module 43 further receives region-distinguishing information transferred from the destination of the output signal. The analysis module 44 analyses the region distinguishing information to determine whether or not the destination of the output signal is located in the regional network where the gateway device 4 is located. If the analysis module 44 determines that the destination of the output signal is located in another regional network different from the regional network in which the gateway device 4 is located, the output signal will be fragmented into several output packets and the second I/O module 43 will output the output packets to a cross-region transferring server. Before the second I/O module 43 outputs the output packets, the destination assigning module 45 assigns the cross-region transferring server as the destination of the output packets. Thus, the output packets are transferred to the destination of the output signal via the cross-region transferring server.

In the present embodiment, the IP address of the gateway device 4 is located in a regional network. The gateway device 4 is signally connected with a terminal device and is cooperated with the cross-region transferring server, which includes at least one cross-region transferring device. The gateway device 4, a regional network and the cross-region transferring device construct a cross-region transferring system. Wherein, the gateway device 4 and the cross-region transferring device are located in the regional network. The gateway device 4 is further signally connected with a terminal device. Therefore, the gateway device 4 can receive the destination of the output signal from the terminal device, and determine whether or not the destination of the output signal is located in the regional network. If not, the gateway device 4 will transfer the output signal to the cross-region transferring device. The cross-region transferring device then transfers the output signal to the destination of output signal through the intranet of the cross-region transferring server.

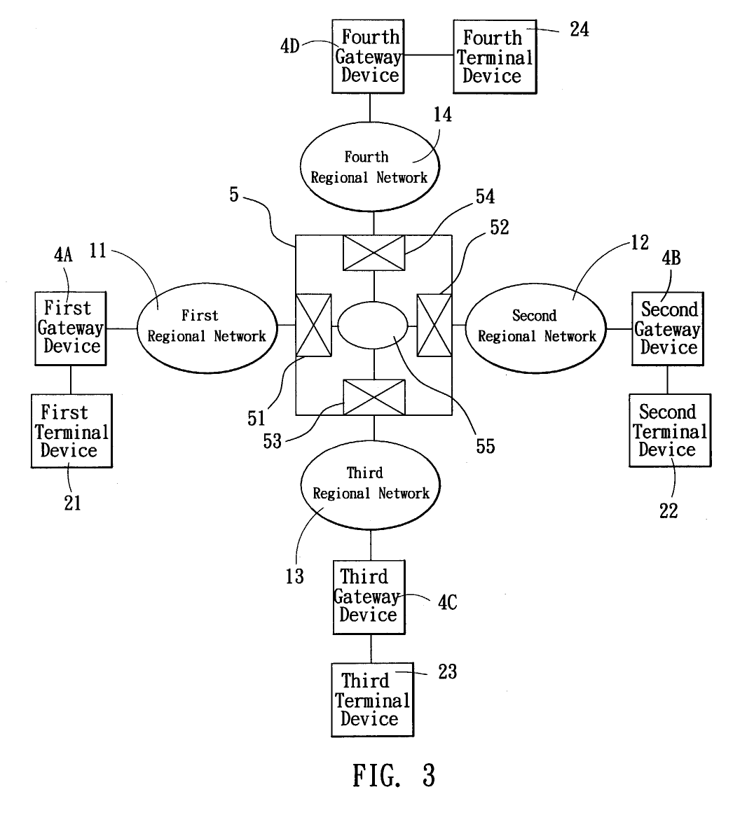

Referring to FIG. 3, several cross-region transferring systems are illustrated. In the embodiment, each cross-region transferring system includes a gateway device, a regional network and a cross-region transferring device. As shown in FIG. 3, a first gateway device 4A, a second gateway device 4B, a third gateway device 4C and a fourth gateway device 4D are signally connected with a first terminal device 21, a second terminal device 22, a third terminal device 23 and a fourth terminal device 24, respectively. The gateway devices 4A-4D are further connected with a first regional network 11, a second regional network 12, a third regional network 13 and a fourth regional network 14, respectively. The cross-region transferring server 5 is a specific network system including several cross-region transferring devices and at least a private network, wherein the cross-region transferring devices are connected with corresponding regional networks. As shown in FIG. 3, the cross-region transferring server 5 includes a first cross-region transferring device 51, a second cross-region transferring device 52, a third cross-region transferring device 53 and a fourth cross-region transferring device 54, which are respectively connected with the first regional network 11, second regional network 12, third regional network 13 and fourth regional network 14. Moreover, the cross-region transferring server 5 further includes a specific network 55 connected with the cross-region transferring devices 51-54.

It should be noted that the data transmission speed between each regional network depends on the contract of each ISP. This means that the bandwidth between the regional networks is limited by contract between the ISPs. In the invention, the cross-region transferring server 5 has a specific network 55, which can be designated as a private network. Therefore, the bandwidth of the specific network 55 can be fully controlled, and the specific network 55 offers truly superior data transmission quality.

The present invention is described in greater detail with reference to the following examples.

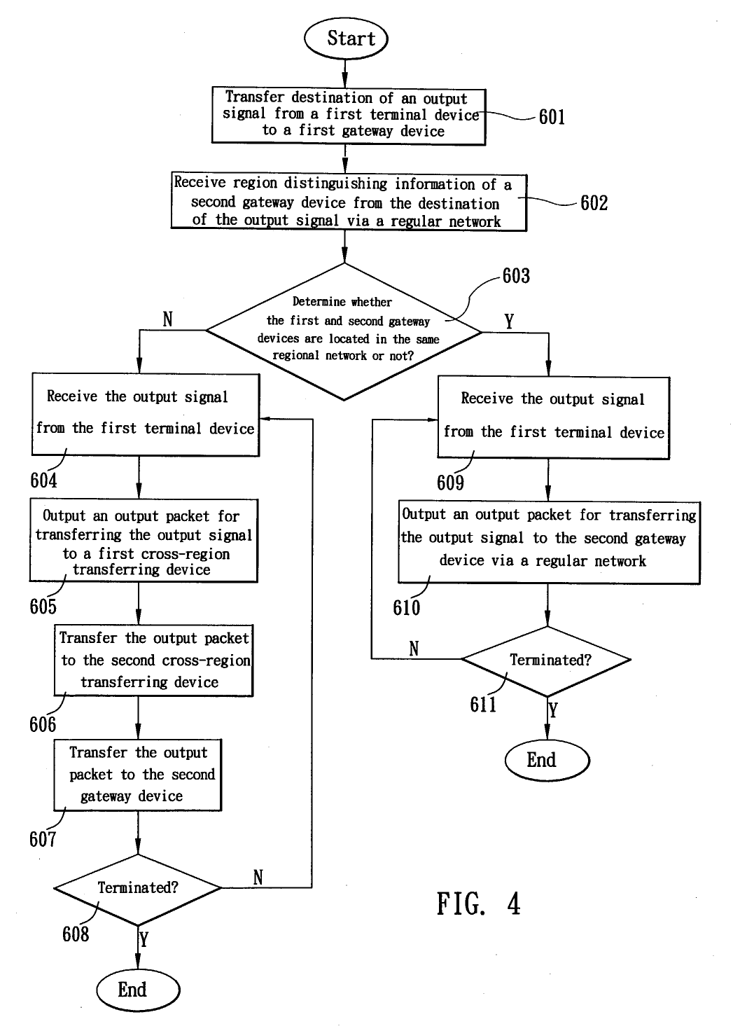

Please refer to FIG. 4. In step 601, when communicating with the second terminal device 22 via the Internet, the first terminal device 21 transfers the destination of the output signal to the first gateway device 4A in advance. Alternatively, the first terminal device 21 can transfer the output signal to the first gateway device 4A, and then the first gateway device 4A analyses the output signal to retrieve the required destination. For example, the output signal is a digital signal while the first terminal device 21 is a computer; or, the output signal may be a voice signal and the destination is expressed by dial tones while the first terminal device 21 is a telephone.

After receiving the destination of the output signal, which is the IP of the second gateway device 4B, the first gateway device 4A receives region distinguishing information from the second gateway device 4B via a regular network in step 602. The first and second gateway device 4A, 4B are both the above-mentioned gateway device 4. In the embodiment, the first I/O module of the first gateway device 4A receives the output signal or the destination thereof. After that, the inquiring signal generating module of the first gateway device 4A generates a region distinguishing information-inquiring signal, the destination of which is the destination of the output signal. Next, the second I/O module of the first gateway device 4A outputs the region distinguishing information-inquiring signal to the first regional network 11. Thus, the region distinguishing information-inquiring signal is transferred to the second gateway device 4B via a regular network. For example, the region distinguishing information-inquiring signal might pass through the first regional network 11, third regional network 13, second regional network 12 and second gateway device 4B in turn. After receiving the region distinguishing information-inquiring signal, the second gateway device 4B responds with the region distinguishing information, which is transferred to the first gateway device 4A via a regular network. The second I/O module of first gateway device 4A then receives the region distinguishing information. The region distinguishing information indicates in which regional network the second gateway device 4B is located.

In step 603, the received region distinguishing information is analyzed so as to determine whether the first and second gateway devices 4A, 4B are located in the same regional network or not. In the embodiment, if the first and second gateway devices 4A, 4B aren't located in the same regional network, the first and second gateway devices 4A, 4B establish a communication channel thereof via the cross-region transferring server 5 (step 604-608). Alternatively, if the first and second gateway devices 4A, 4B are located in the same regional network, the first and second gateway devices 4A, 4B establish a communication channel thereof via a regular network (step 609-611).

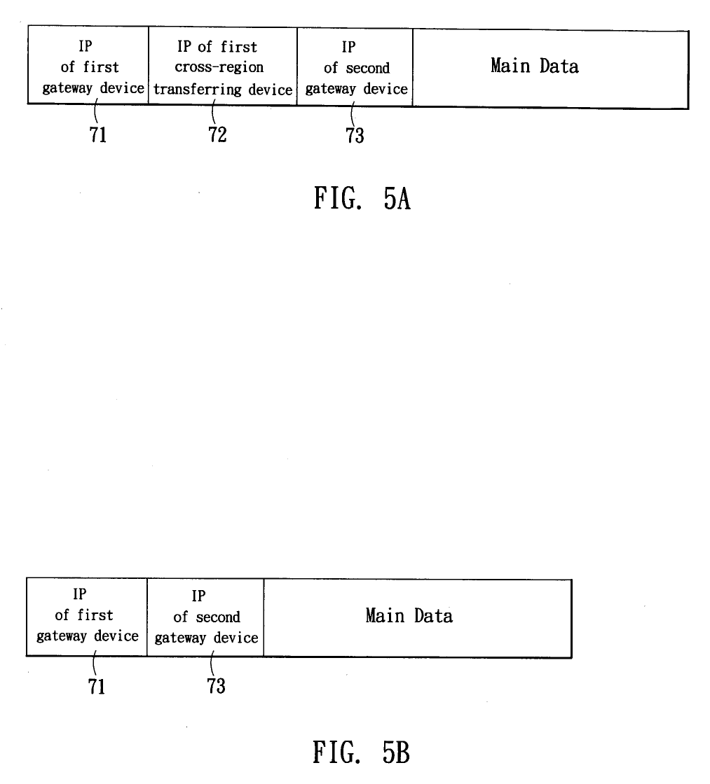

The first gateway device 4A receives the output signal from the first terminal device 21 in step 604. Furthermore, the first gateway device 4A translates and fragments the output signal into output packets in cases where the output signal isn't a packet formation. After that, in step 605, the destination assigning module of the first gateway device 4A indicates the destination of the output packets as the first cross-region transferring device 51. Then, the second I/O module of the first gateway device 4A outputs the output packets to the first cross-region transferring device 51 via the first regional network 1I. The above-mentioned output packets are shown in FIG. 5A. The header of each output packet should include the IP of the first gateway device 71 and the IP of the first cross-region transferring device 72.

The destination of the output signal, as well as the IP of the second gateway device 73, is also recorded in each output packet.

In step 606, the output packets are transferred in the cross-region transferring server 5. In detail, the output packets are transferred from the first cross-region transferring device 51 to the second cross-region transferring device 52 via the specific network 55. In step 607, the second cross-region transferring device 52 transfers the output packets to the second gateway device 4B, and then the second gateway device 4B transfers the output packets to the second terminal device 22. The output packets transferred to the second gateway device 4B are shown in FIG. 5B, wherein the header of each output packet should include the IP of the first gateway device 71 and the IP of the second gateway device 73. Finally, step 608 determines whether the communication is terminated or not. If not, steps 604-608 are repeated; if so, the procedure is terminated.

Furthermore, when the first and second gateway devices 4A, 4B are located in different regional networks, the first gateway device 4A is further able to receive at least one input packet transferred from the second gateway device 4B via the cross-region transferring server 5. In this case, the input packet has a data structure similar to a conventional regular packet. The destination of the input packet is the IP of the first gateway device 4A, while the source of the input packet is the IP of the second gateway device 4B. The first I/O module of the first gateway device 4A further translates the input packet into an input signal and outputs the input signal to the first terminal device 21. In the embodiment, the input signal could be a digital signal, an analog signal, or a voice signal.

When the first and second gateway devices are located in the same regional network (not shown in FIG. 3), the first gateway device receives the output signal from the first terminal device (step 609). If the output signal isn't a packet formation, the first gateway device will translate the output signal into an output packet. Next, in step 610, the first gateway device transfers the output packet to the second gateway device via a regular network, which is the first regional network. The output packet is shown in FIG. 5B. Finally, the step 611 determines whether the communication is terminated or not. If not, steps 609-611 are repeated; if so, the procedure is terminated.

It should be noted that the first gateway device 4A is able to establish a communication channel with any other gateway device via the cross-region transferring server 5, for instance, the second gateway device 4B or the third gateway device 4C shown in FIG. 3.

In summary, since the gateway device of the invention determines the destination of the output signal is located in another regional network in advance, the output signal can be transferred to the cross-region transferring server of the invention accordingly. Then, the cross-region transferring server transfers the output signal to the destination thereof, which is located in another regional network. Thus, the data could be transferred via the superior specific network, which is part of the cross-region transferring server.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A gateway device, which is located in a regional network, signally connects to a terminal device and cooperates with a cross-region transferring server, comprising:
a first I/O module, which receives a destination of an output signal from the terminal device;
an inquiring signal-generating module, which generates a region distinguishing information-inquiring signal according to the destination of the output signal;
a second I/O module, which outputs the region distinguishing information-inquiring signal to the destination of the output signal at least via the regional network, and receives region destination information from the destination of the output signal; and
an analysis module, which analyses the region distinguishing information to determine whether the destination of the output signal is located in the regional network or not,
wherein, when the destination of the output signal is not located in the regional network, the second I/O module outputs the output signal to the cross-region transferring server via the regional network, and the cross-region transferring server transfers the output signal to the destination of the output signal.

2. The gateway device of claim 1, wherein the second I/O module outputs the output signal in way of at least one output packet.

3. The gateway device of claim 2, further comprising:
a destination assigning module, which assigns the cross-region transferring server as the destination of the output packet and records the destination of the output signal in the output packet when the destination of the output signal is not located in the regional network.

4. The gateway device of claim 2, wherein the destination of the output packet is assigned as the destination of the output signal when the destination of the output signal is located in the regional network.

5. The gateway device of claim 1, wherein the second I/O module further receives at least an input packet from the destination of the output signal via the cross-region transferring server.

6. The gateway device of claim 5, wherein the destination of the input packet is the IP address of the gateway device while the source of the input packet is the destination of the output signal.

7. The gateway device of claim 5, wherein the first I/O module further outputs the input packet to the terminal device by way of an input signal.

8. The gateway device of claim 7, wherein the input signal is a digital signal.

9. The gateway device of claim 7, wherein the input signal is an analog signal.

10. The gateway device of claim 7, wherein the input signal is a voice signal.

11. The gateway device of claim 1, wherein the input signal is a digital signal.

12. The gateway device of claim 1, wherein the input signal is an analog signal.

13. The gateway device of claim 1, wherein the input signal is a voice signal.

14. A cross-region transferring system, which cooperates with a terminal device, comprising:
a regional network;
a gateway device, which signally connects to the terminal device and connects to the regional network; and
a cross-region transferring device, which connects to the regional network,
wherein, the gateway device receives the destination of an output signal form the terminal device, determines whether or not the destination of the output signal is located in the regional network, and transfers the output signal to the cross-region transferring device when the destination of the output signal is not located in the regional network, and the output signal is transferred to the destination of the output signal via the cross-region transferring device.

15. The cross-region transferring system of claim 14, wherein the gateway device comprises:
a first I/O module, which receives the destination of the output signal from the terminal device;
an inquiring signal generating module, which generates a region distinguishing information inquiring signal according to the destination of the output signal;
a second I/O module, which outputs the region distinguishing information inquiring signal to the destination of the output signal at least via the regional network, and receives region destination information from the destination of the output signal; and
an analysis module, which analyses the region distinguishing information to determine whether or not the destination of the output signal is located in the regional network,
wherein, when the destination of the output signal is not located in the regional network, the second I/O module outputs the output signal to the cross-region transferring device via the regional network, and the cross-region transferring device transfers the output signal to the destination of the output signal.
